(19) United States
(12) Patent Application Publication
(10) Pub. No.: US 2019/0329248 A1
(43) Pub. Date: Oct. 31, 2019

(54) VIAL, METHOD FOR TRANSPORTING VIALS, AND USE OF A VIAL

(71) Applicant: NOLATO TREFF AG DEGERSHEIM, Degersheim (CH)

(72) Inventors: Joerg SCHERRER, Degersheim (CH); Philipp CRAMER, Rapperswil (CH); Werner BRUESTLE, Lustenau (AT); Richard WIESLI, Teufen (CH)

(21) Appl. No.: 16/074,201

(22) PCT Filed: Feb. 8, 2016
(86) PCT No.: PCT/EP2016/052629

§ 371 Date: Jul. 31, 2018

(51) Int. Cl. B01L 3/00; B65G 51/06

(52) U.S. Cl. CPC B01L 3/50825; B65G 51/06; B01L 2300/044; B01L 2300/0832; B01L 2300/042; B01L 2200/18

(57) ABSTRACT

A vial (1) for use in an air flow-operated tube mail system. The vial comprises a body (2) and a lid (3). The body has an open end and a closed end. The lid can at least be partially inserted into the open end of the body (2) in order to close the body (2). The lid further comprises at least one plastic component (3″) that is designed such that, after a penetration by a cannula having a diameter of 2 mm, the plastic component is tight up to at least 2 bar internal pressure,

The present invention relates to vials, a method for transporting vials, and the use of vials, according to the independent claims.

Vials are used, inter alia, for the storage, analysis and transport of chemical and biological samples. The transport can here be realized, for instance, via airflow-operated tube mail systems. To this end, the vials are hermetically sealed and dispatched with the aid of airflow via the tubes of the system. Similar systems are known in larger construction, for instance from hospitals, for the dispatch of specimens or medical records.

Preferably, the vials are sent in such airflow-operated tube mail systems to an analytical apparatus. The airflow can either be provided by compressed air or by a vacuum. There a specimen is preferably removed automatically with the aid of a cannula. The vial is afterward sent into the garbage or into a storage area, according to requirement.

For conveyance in automated tube mail systems, certain requirements are placed upon the vials. Thus the closure of the vials must allow an automated specimen collection. Moreover, the closure must ensure that the content does not unintentionally escape. A contamination of the system by a sample would be disastrous, since a cross-contamination with other samples, for instance, could no longer be precluded.

An object of the present invention is therefore to provide vials which are suitable for use in airflow-operated tube systems. This object is achieved with vials of the independent claims.

The vial comprises a body and a cap. The body has an open end and a closed end. The cap can be inserted at least partially into the open end of the body in order to plug the body. The cap further comprises at least one plastics component, which is configured such that, after penetration with a cannula having a diameter of up to 2 mm, it is leaktight at least up to 2 bar internal pressure.

The cap and the body are preferably configured such that the vial, in the closed state (i.e. prior to the first penetration), is leaktight at least up to 5 bar internal pressure. By a leaktight cap, the content of the vial is prevented from escaping when the vial is transported by means of airflow. The cap should here be configured such that it is leaktight also against capillary or creeping forces.

The at least one plastics component has a Shore hardness which allows penetration with a cannula and automatically reseals the puncture following removal of the cannula. After the penetration with a cannula of approximately 2 mm, the cap is still leaktight up to at least 2 bar internal pressure. As a result, even after a first sample collection, a hermetic sealing without risk of contamination of the tube mail system is ensured. The vial is here preferably configured such that the cap is leaktight, even after repeated penetration, up to at least 2 bar internal pressure.

Preferably, the cap has two plastics components or consists of two plastics components. The two components differ in terms of their Shore hardness. The component having the lower Shore hardness is disposed in a region of the cap radially within the component having the higher Shore hardness. Moreover, the Shore harder component, at least in a region of the cap which is insertable into the body, is configured without interruption in the peripheral direction.

The component having the lower Shore hardness allows the penetration with the cannula and subsequent sealing against an internal pressure, as previously described. The Shore harder component, by virtue of the uninterrupted configuration at least in the region which is introduced into the body, lends the cap additional stability. Through the increased stability, the leak-tightness of the cap can in turn be enhanced. Thus, for instance, by virtue of the Shore harder component, the contact pressure force between body and cap remains substantially the same, even after lengthy storage.

If the Shore harder component constitutes the radially outermost layer, it ensures a contact between body inner surface and cap outer surface, which contact seals the content of the vial against the outside.

Alternatively, an additional component can be present in a radially outermost location, at least in the region which is inserted into the body. This layer is preferably formed of a Shore softer plastic than the circumferentially configured Shore harder component. With the aid of the Shore softer component, an enhanced sealing effect between cap and vial can in turn be achieved.

The Shore softer component is preferably at least partially surrounded, in that region of the cap which is insertable into the body, in the peripheral direction by the Shore harder component.

As a result of such an arrangement, the cap, in the region which is insertable into the body, is of stable configuration.

The Shore softer component of the cap can be surrounded, over the entire length in the direction of the longitudinal axis of the vial in the peripheral direction, by the Shore harder component, or else, at least in a point of the cap which is not inserted into the body, can run radially outward.

The Shore softer component can also, in the region which is inserted into the body, be present only over a certain length. In one region, only the Shore harder component, for example, is in this case present, which thus forms a cavity.

It is also possible that the Shore softer component, for instance, at the end pointing in the direction of the closed end, runs radially outward. The Shore softer component can thus be surrounded by the Shore harder component only over a specific length in the region which can be arranged within the cap.

Preferably, the Shore harder component is a polypropylene and the Shore softer component a thermoplastic elastomer. The thermoplastic elastomer preferably has a Shore hardness within the range 35-48 Shore A, measured according to ISO 7619.

A thermoplastic elastomer is well suited to the particular requirements. Thus, the thermoplastic elastomer allows the penetration with the cannula. Furthermore, the thermoplastic elastomer seals off the pass-through point after removal of the cannula, again with the desired leak tightness.

Other plastics which meet the penetration and sealing requirements are conceivable.

Preferably, the Shore softer component has in a direction perpendicular to the longitudinal axis of the vial a dimension of 3-6 mm, preferably 4.5 mm. In the direction of the longitudinal axis, it preferably has a dimension of 1-4 mm, preferably 2 mm.

With the preferred dimensions, sealing after passage and removal of the cannula can be ensured. Moreover, the dimensions are well suited to vials which are employed in tube mail systems.

Other dimensions of the Shore softer component are possible for vials, according to the requirement profile.

Preferably, the body of the vial contains polypropylene or consists thereof.

Polypropylene is well suited to vials in airflow-operated tube mail systems, because the material ensures that the vial does not shatter or get damaged. Moreover, bodies are able to be produced from polypropylene, for instance, in an injection molding process. Polypropylene can, moreover, be worked such that no edges or projections, on which two vials in the system could catch together or interlock, are present. It should be ensured that such catching does not occur, since this could hamper a frictionless transport of the vials.

Alternatively, other plastics which allow an edge-free and projection-free production are also conceivable.

The cap and the body are preferably configured such that the cap and the body can enter into operative connection via a snap fastening.

A form closure via a snap connection ensures that the cap and the body are fixedly connected to each other. An unintentional opening of the vial is thereby prevented.

Alternatively, other closures too are conceivable. For instance, the closure could be configured as a ratchet mechanism such that opening after the closure would no longer be possible, or only by damaging the cap.

The snap fastening is preferably formed by a notch in the peripheral direction in the cap and a complementary bead in the body.

The snap connection here ensures a pressure-resistant closure. Moreover, a body with a bead and a cap with a notch are able to be produced relatively easily.

Alternatively, the cap can also have a bead, and the body a notch.

Preferably, at least an outer surface of the cap, which is insertable into the body, and an inner surface of the body, which can come into contact with the cap, is configured substantially smooth, without edges running in the direction of the longitudinal axis of the vial.

Smooth and edge-free should here be understood as meaning that no unwanted irregularities are present. In the direction of the longitudinal axis, no edges or notches should be present, since otherwise capillaries can arise, through which the sample can flow or creep. These smooth and edge-free surfaces ensure a sealtight contact. Since the position of the vials within the tube system is arbitrary and can also change according to choice, it should be ensured that the cap, in any position of the vial, is sealtight in the required order of magnitude.

Preferably, the body has at least one conically tapered portion on the outer side. This conical portion comprises the closed end.

Such a geometry ensures, in turn, that no catching takes place between two vials. Moreover, the vial can be automatically transferred into a correct position when the position is recognized with the aid of the geometry. Thus, for a specimen collection through the cannula, for instance, the vial can be brought into an upright position.

Alternatively, the vial can also have a different geometry. Thus, a conical portion on the outer side, for instance, can be absent.

Preferably, the body is configured such that it has a conicity in a lower quarter of 10-15° and a conicity in an upper part of 1-5°.

These angles ensure a smooth-running process in the tube system without catching.

It is also possible that only the lower quarter or only the upper part are conically configured.

Preferably, the body has on an outer surface a flange at the open end.

A flange enables simple gripping of the vial with a fork-shaped carrying element. The carrying element should here be configured such that a distance between the arms is larger than the diameter of the vial beneath the flange, but smaller than the diameter of the vial close to the flange. Thus, the vial can be led into the arms and raised.

Moreover, the flange ensures that, if a cap having a larger diameter than the vial is used, no additional edge is formed by the cap. To this end, the flange is preferably of conical configuration, wherein the largest diameter is arranged at the open end. This largest external diameter of the flange should here correspond to the external diameter of the cap in order that no additional edge is formed.

In a preferred embodiment, the body comprises two plastics components or consists thereof. At least one component is here of non-transparent or opaque configuration and is disposed at the closed end of the body. This at least one non-transparent or opaque component has a code, preferably a 2D-barcode, particularly preferably a data matrix code, for identification.

With the aid of the code, the vial, and hence the sample, can be clearly labeled and identified. Hence the vial can be easily handled by fully automatic means, and the specimen of the vial correctly assigned. Moreover, such a code allows an anonymization of the vial or sample.

Alternatively, a different code than a 2D code can be used, such as, for instance, a color code.

Preferably, the non-transparent or opaque component contains polypropylene or consists thereof.

Polypropylene allows simple production of a non-transparent or opaque component. Moreover, it allows production in a 2 K injection molding process, together with the rest of the body.

Alternatively, the non-transparent or opaque component can also be produced from another suitable material.

Preferably, the vial has a capacity of maximally 350 pl.

For analyses, often only a few microliters of the sample are required. Therefore the vial should not have too large a capacity, in order that not too much sample is required. In the event of a large capacity and little sample, there is the danger that the sample is distributed in the vial such that a specimen collection is made more difficult or can no longer be ensured.

According to application, vials with larger capacity are also, however, conceivable. Thus, vials with a capacity of several milliliters, for instance 2.5 or 5 ml, could also be employed, for instance, in airflow-operated tube systems.

Preferably, the cap and/or the body of the vial is produced by an injection molding process, preferably a 2 K injection molding process.

An injection molding process allows the parts of the vial to be produced with constant, high quality. By the 2 K injection molding process, the parts comprising two plastics components can be produced in one production process.

An alternative embodiment according to the invention relates to a vial which once again comprises a body and a cap. The body here has, once again, an open end and a closed end, and the cap is partially insertable into the open end of the body in order to plug the body. A cavity of the body has in the region of the closed end a smaller diameter than in a region of the open end.

The diminution of the cavity can be realized continually, with the aid of a conically tapered portion, or in steps. Both steps and conical portions can also be present. The conicity in the lower region is here preferably configured somewhat stronger than in an upper region. Preferably, the lower region has an angle of 10-45°, particularly preferably 30°.

The cavity in a lower region advantageously has a mean diameter of 20-70%, particularly advantageously 50%, of the mean diameter of the upper region.

The feature of the smaller diameter in the region of the closed end of the alternative embodiment is advantageous per se, but can also be present in all variants of the previously described embodiment.

Through the diminution of the diameter close to the closed end, vials having lesser capacity but the same external geometry as vials having a greater capacity can be produced. As a result, vials with different capacity can be used within the same tube system. The airflow-operated tube system places specific requirements on the dimensions of the vials in order that a smooth-running process can be ensured. The dimensions are dependent on the use of the tube system or the dimension of the tubes and of the used air pressures.

Moreover, as a result of a lesser diameter of the cavity at the closed end, a specimen collection in the event of low quantities is made easier. The sample will in the small diameter reach a higher fill height than in vials with larger diameter. Hence, with the aid of the cannula, the sample can be better received.

The diminution of the cavity is configured differently strongly, according to the desired fill quantity.

The invention further relates to a method for transporting vials in a tube system with airflow. In the method, one of the previously described vials is used.

The invention further relates to the use of one of the previously described vials in an airflow-operated tube system.

Further advantageous embodiments of the invention emerge from the following description of the illustrative embodiments in combination with the schematic figures, wherein:

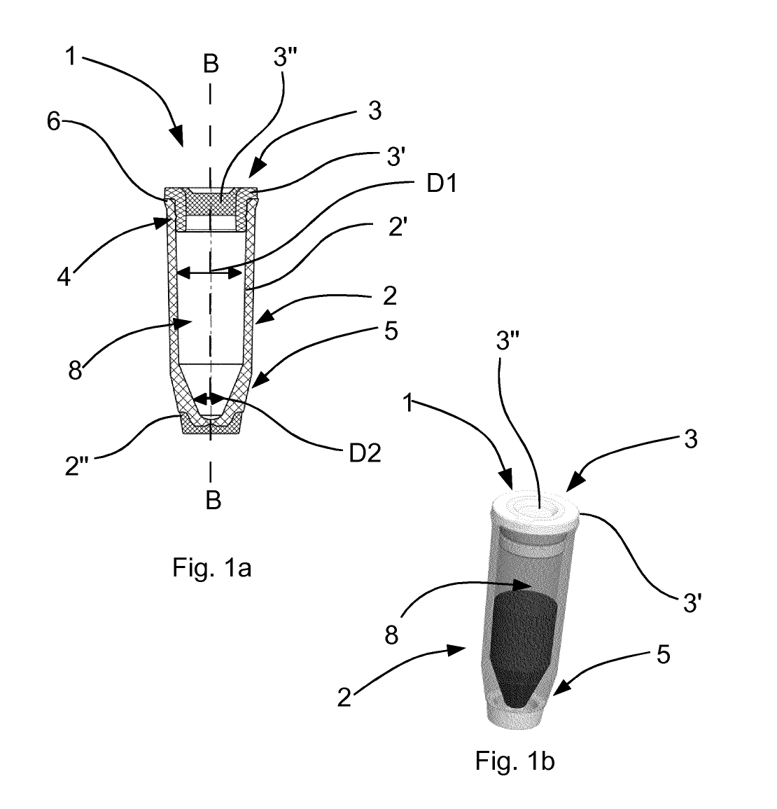

FIG. 1a: shows schematically a longitudinal section through a vial according to the invention;

FIG. 1b: shows an external view of the vial according to FIG. 1a;

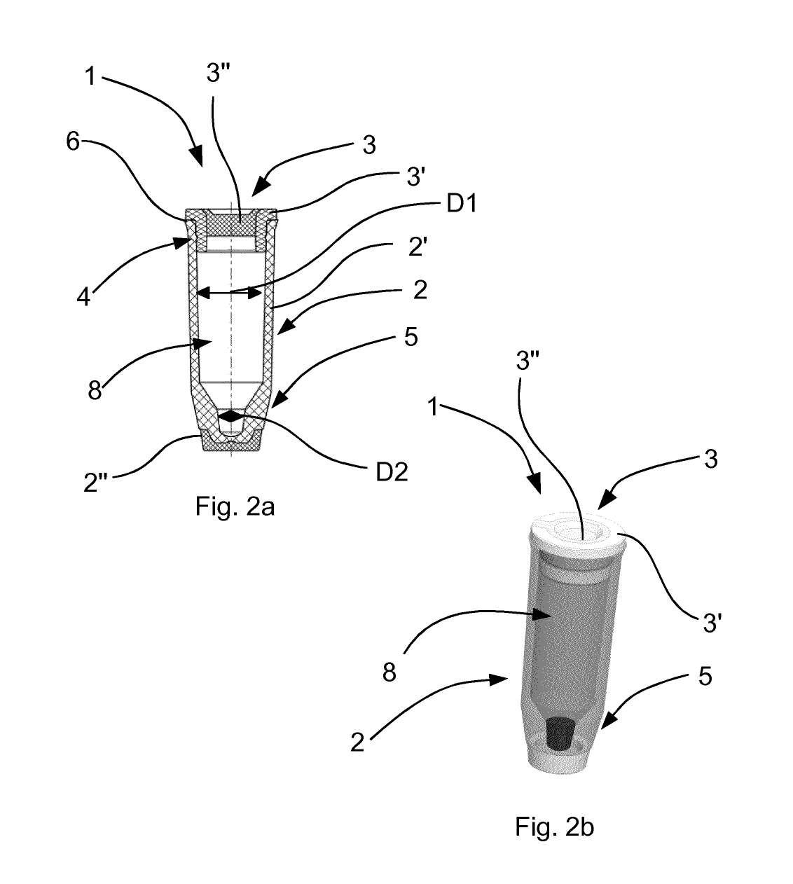

FIG. 2a: shows schematically a longitudinal section through a further vial according to the invention;

FIG. 2b: shows schematically an external view of the vial according to FIG. 2a;

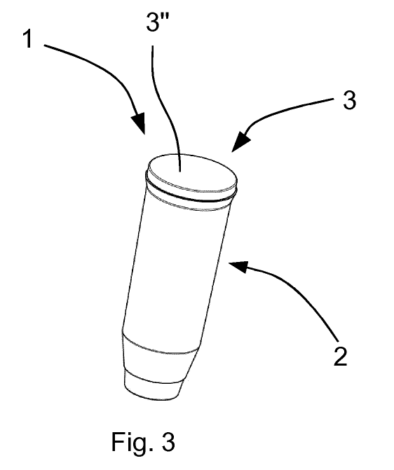

FIG. 3: shows schematically an external view of a further vial according to the invention.

FIG. 1a shows a longitudinal section through a vial 1 according to the invention. FIG. 1b shows an external view of the same vial 1. The vial 1 has a body 2 and a cap 3. The cap 3 is inserted in an open end of the body 2 in order to plug the vial 1.

The cap 3 is formed of two components 3′, 3″, which differ in terms of their Shore hardness. The cap 3 is produced with a 2 K injection molding process. The Shore harder component 3′ is a polypropylene. The Shore softer component 3″ is a thermoplastic elastomer having a Shore hardness of 40 Shore A, measured according to ISO 7619. In a region of the cap 3 which is insertable into the body 2, the Shore softer component 3″ is completely surrounded in the peripheral direction by the Shore harder component 3′. In an upper end of the cap 3, the Shore softer component 3″, by contrast, runs radially outward (see FIG. 1b). The Shore softer component 3″ extends only over a partial section, in the direction of the longitudinal axis of the vial 1, of the Shore harder component 3′. An end of the cap 3, pointing in the direction of the closed end, is formed only by the Shore harder component 3′, which forms an additional cavity that is open on one side.

The Shore softer component 3″ has a dimension of 4.5 mm in the direction of a longitudinal axis B of the vial 1, and 2 mm in a direction perpendicular to the longitudinal axis B of the vial 1. The Shore softer component 3″ allows a penetration of the cap with a cannula for the specimen collection. Following removal of the cannula from the cap 3, the Shore softer component 3″ plugs the pass-through opening automatically. Prior to a penetration with the cannula, the vial 1 is leaktight against 5 bar internal pressure. Following the penetration, the vial is still leaktight against 2 bar internal pressure.

A connection between cap 3 and body 2 is additionally improved by a form closure in the form of a snap connection 4. The snap connection 4 is formed by a bead on the inner surface of the body 2 and a notch on the outer surface of the cap 3.

The body 2 is formed by two plastics components 2′, 2″. Both components 2′, 2″ are polypropylene, wherein one component 2″ is of opaque configuration. The body 2 is in turn formed with a 2 K injection molding process. The opaque component 2″ is disposed on a closed end of the body 2. On its face pointing away from the body 2, the opaque component has a data matrix code (not shown). The code serves for the identification of the vial. The vial can hence be automatically assigned and processed in the tube system.

At the open end, the body 2 has a flange 6, which is formed by the non-opaque polypropylene component 2′. The flange 6 ensures that in the tube system two vials 1 do not catch together with their caps 3. The vial 1 has close to the flange 6 almost the same external diameter as the cap 3, so that virtually no additional edge is formed. At the closed end, the external wall runs in one portion 5 conically. The portion has a conicity of 10°. The upper portion has a low conicity of 2°.

Moreover, a cavity 8 is present within the body 2. The cavity 8 serves to receive samples which are transported in the tube system and has a filling capacity of 350 μl. The cavity 8 has in the lower quarter an inner conical portion having a conicity of 33°. The upper part hence has a substantially larger diameter D1 than the cavity at the closed end D2. The diameter D2 is shown by way of example at a single site, since the conical portion does not have a single diameter.

FIGS. 2a and 2b show an alternative embodiment according to the invention of a vial 1. The vial 1 of FIGS. 2a and 2b differs substantially in that the cavity 8 has in the lower quarter a higher conicity of 34°. Moreover, the cavity possesses in the lowermost portion a roughly cylindrical portion. Hence the cavity 8 of FIG. 2 has a volume of only 200 μl. The vial 1 of FIGS. 2a and 2b possesses, however, the same external dimensions as the vial 1 of FIGS. 1a and 1b.

The geometry of the cavity 8 of FIG. 2 allows filling with low quantities. The small quantities will be deposited in the lowermost, cylindrical portion of the cavity 8. As a result of the small diameter D2 of the portion, a certain fill height is reached, however, despite the low quantity (see FIG. 2b). It can hence be ensured that a specimen can be collected with the cannula, without the cannula having to pass right through to the bottom.

FIG. 3 shows an external view of an alternative vial 1 according to the invention. The vial 1 of FIG. 3 differs from the vials of FIGS. 1a-2b in that the cap 3 consists only of one component 3″. The component 3″ is constituted by the thermoplastic elastomer, which is used also in the caps of FIGS. 1a-2b. The component 3″ allows the entry of a cannula and a following automatic sealing of the point of entry.

1. A vial for use in an airflow-operated tube mail system, comprising:
a body and a cap,
wherein the body has an open end and a closed end and the cap can be inserted at least partially into the open end of the body in order to plug the body,
the cap comprises at least one plastics component, which is configured such that, after penetration with a cannula having a diameter of 2 mm, it is leaktight at least up to 2 bar internal pressure.

2. The vial as claimed in claim 1, wherein the cap and the body are configured such that the vial, in the closed state, is leaktight at least up to 5 bar internal pressure.

3. The vial as claimed in claim 1, wherein the cap comprises two plastics components and the two components differ in terms of their Shore hardness, wherein the component having the lower Shore hardness is disposed in a region of the cap radially within the component having the higher Shore hardness.

4. The vial as claimed in claim 3, wherein the component having the lower Shore hardness is at least partially surrounded, in that region of the cap which is insertable into the body, in a peripheral direction by the component having the higher Shore hardness.

5. The vial as claimed in claim 3, wherein the component having the higher Shore hardness is a polypropylene, and the component having the lower Shore hardness is a thermoplastic elastomer.

6. The vial as claimed in claim 3, wherein the component having the lower Shore hardness has, in a direction perpendicular to a longitudinal axis of the vial, a dimension of 3-6 mm, and in the direction of the longitudinal axis of the vial a dimension of 1-4 mm.

7. The vial as claimed in claim 1, wherein the body contains polypropylene.

8. The vial as claimed in claim 1, wherein the cap and the body are configured such that the cap and the body can enter into operative connection via a snap fastening.

9. The vial as claimed in claim 8, wherein the snap fastening is formed by a notch in a peripheral direction in the cap and a bead in the body.

10. The vial as claimed in claim 1, wherein at least an outer surface of the cap, which is insertable into the body, and an inner surface of the body, which can come into contact with the cap, are configured substantially smooth and without edges running in a direction of a longitudinal axis of the vial.

11. The vial as claimed in claim 1, wherein the body has at least one conically tapered portion on an outer side, and the at least one conical portion has the closed end or is arranged adjacent thereto.

12. The vial as claimed in claim 11, wherein a conicity in a lower quarter of the vial is 10-15°, and/or in an upper part of the vial is 1-5°.

13. The vial as claimed in claim 1, wherein the body has on an outer surface a flange at the open end.

14. The vial as claimed in claim 1, wherein the body comprises two plastics components, wherein at least one component is of non-transparent or opaque configuration and is disposed at the closed end of the body, and this at least one non-transparent or opaque component has a code.

15. The vial as claimed in claim 14, wherein the at least one non-transparent or opaque component contains polypropylene.

16. The vial as claimed in claim 1, wherein the vial has a capacity of maximally 350 μl.

17. The vial as claimed in claim 1, wherein the the body and/or the cap is produced by an injection molding process.

18. A vial, comprising:
a body and a cap,
wherein the body has an open end and a closed end, and the cap is partially insertable into the open end of the body in order to plug the body,
wherein a cavity of the body has, in a region of the closed end, a smaller diameter than in a region of the open end.

19. The vial as claimed in claim 18, wherein the diameter of the cavity has in a region of the closed end 20-70% of a diameter of the cavity in the region of the open end.

20. The vial as claimed in claim 18, wherein the cavity has a step, which is configured such that the cavity has, in a region of the closed end, a smaller diameter than in a region of the open end.

21. A method for transporting vials in a tube system with airflow, wherein a vial as claimed in claim 1 is used.

22. The vial as claimed in claim 3, wherein the component having the harder Shore hardness, at least in a region of the cap which is intertable into the body, is configured without interruption in the peripheral direction.

23. The vial as claimed in claim 3, wherein the component having the lower Shore hardness has a Shore hardness in a region of 35-48 Shore A, measured according to ISO 7619.
